(19) United States
(12) Patent Application Publication
(10) Pub. No.: US 2016/0197496 A1
(43) Pub. Date: Jul. 7, 2016

(54) ENERGY DEVICES WITH ULTRA-CAPACITOR STRUCTURES AND METHODS THEREOF

(71) Applicant: THE PAPER BATTERY COMPANY, INC., Troy, NY (US)

(72) Inventors: Dave RICH, East Greenbush, NY (US); Staci TRIFILO, Scotia, NY (US)

(73) Assignee: THE PAPER BATTERY COMPANY, INC., Troy, NY (US)

(21) Appl. No.: 14/590,386

(22) Filed: Jan. 6, 2015

(51) Int. Cl. H02J 7/00; H01M 10/44; H01M 10/46; H01M 16/00

(52) U.S. Cl. CPC H02J 7/007; H01M 16/00; H01M 10/44; H01M 10/46; H02J 7/0029; H01M 2220/30

(57) ABSTRACT

Energy devices with ultra-capacitor structures and methods thereof are presented. The energy devices include, for example: an ultra-capacitor structure having a power input terminal; and a battery structure electrically connected to the ultra-capacitor structure via a switching element, the switching element being selectively controllable between a first state and a second state, wherein the first state functions as a pass through to electrically connect the battery structure to the power input terminal of the ultra-capacitor structure, and the second state functions to electrically isolate the battery structure from the power input terminal of the ultra-capacitor structure. The methods include: selectively charging the battery structure through the ultra-capacitor structure using at least a portion of the electrical power provided to the power input terminal thereof.

### CROSS-REFERENCE TO RELATED APPLICATIONS

This application is related to U.S. patent application Ser. No. 14/041,624, filed Sep. 30, 2013, U.S. patent application Ser. No. 14/215,571, filed Mar. 17, 2014, U.S. patent application Ser. No. 14/485,962, filed Sep. 15, 2014, and U.S. patent application Ser. No. 14/576,316, filed Dec. 19, 2014, all of which are hereby incorporated herein by reference in their entirety.

### FIELD OF THE INVENTION

The present invention relates to energy devices and methods thereof, and more particularly to energy devices with ultra-capacitor structures and methods thereof.

### BACKGROUND OF THE INVENTION

Consumer demand continues for modern portable electronic devices with increased functionality and increased operation time. Because portable electronic devices can include numerous components, each of which can require significant power and different voltages, powering such devices and optimizing energy device lifetime and cycle times under varying consumer usage patterns can present problems.

For instance, under certain conditions, such as near depletion, rapid charging can irreparably damage a conventional battery, reducing the number of useful cycles of the battery. In addition, a typical usage pattern of a mobile electronic device may include the need to rapidly charge the device to enable continued usage. Further, a conventional battery can require a charge time measured in hours, limiting consumer usage of mobile electronic devices. Therefore, a tradeoff is typically made between the speed at which a conventional battery is charged and the resulting cycle life. In addition, because the power stored in a battery may not be used optimally, a significant portion of the power can be lost, leading to reduced power-on times or the provision of larger batteries, thereby increasing the size of mobile electronic devices.

### BRIEF SUMMARY

The shortcomings of the prior art are overcome, and additional advantages are provided, through the provision, in one aspect, of an energy device. The energy device includes: an ultra-capacitor structure having a power input terminal; and a battery structure electrically connected to the ultra-capacitor structure via a switching element, the switching element being selectively controllable between a first state and a second state, wherein the first state functions as a pass through to electrically connect the battery structure to the power input terminal of the ultra-capacitor structure, and the second state functions to electrically isolate the battery structure from the power input terminal of the ultra-capacitor structure.

In another aspect, a method is presented. The method includes: providing an energy device comprising: an ultra-capacitor structure having a power input terminal; and a battery structure electrically connected to the ultra-capacitor structure; providing electrical power to the power input terminal of the ultra-capacitor structure; and selectively charging the battery structure through the ultra-capacitor structure using at least a portion of the electrical power provided to the power input terminal thereof.

In another aspect, an electronic system is presented. The electronic system includes: an energy device, the energy device comprising: an ultra-capacitor structure having a power input terminal; and a battery structure electrically connected to the ultra-capacitor structure via a switching element, the switching element being selectively controllable between a first state and a second state, wherein the first state functions as a pass through to electrically connect the battery structure to the power input terminal of the ultra-capacitor structure, and the second state functions to electrically isolate the battery structure from the power input terminal of the ultra-capacitor structure; and a power supply, the power supply being electrically connected to the power input terminal of the ultra-capacitor structure, wherein the power supply charges the battery structure in the first state of the switching element.

Additional features and advantages are realized through the techniques of the present invention. Other embodiments and aspects of the invention are described in detail herein and are considered a part of the claimed invention.

### BRIEF DESCRIPTION OF THE SEVERAL VIEWS OF THE DRAWINGS

One or more aspects of the present invention are particularly pointed out and distinctly claimed as examples in the claims at the conclusion of the specification. The foregoing and other objects, features, and advantages of the invention are apparent from the following detailed description taken in conjunction with the accompanying drawings in which:

FIG. 1A is a block diagram of an electronic system with an energy device, in accordance with one or more aspects of the present invention;

FIG. 1B depicts the energy device of FIG. 1A in a pass through state electrically connecting the battery structure to the power input terminal thereof, in accordance with one or more aspects of the present invention;

FIG. 1C depicts the energy device of FIG. 1B in a state electrically connecting the battery structure to the power output terminal thereof, in accordance with one or more aspects of the present invention;

FIG. 1D depicts the energy device of FIG. 1C in a state electrically connecting the ultra-capacitor structure and the battery structure to the power output terminal thereof, in accordance with one or more aspects of the present invention;

FIG. 1E depicts the energy device of FIG. 1D in a state electrically connecting the ultra-capacitor structure to the power output terminal thereof, in accordance with one or more aspects of the present invention; and

FIG. 2 is a cross-sectional elevational view of an ultra-capacitor structure, in accordance with one or more aspects of the present invention.

### DETAILED DESCRIPTION

Aspects of the present invention and certain features, advantages, and details thereof, are explained more fully below with reference to the non-limiting examples illustrated in the accompanying drawings. Descriptions of well-known materials, fabrication tools, processing techniques, etc., are omitted so as not to unnecessarily obscure the invention in detail. It should be understood, however, that the detailed description and the specific examples, while indicating aspects of the invention, are given by way of illustration only, and not by way of limitation. Various substitutions, modifications, additions, and/or arrangements, within the spirit and/or scope of the underlying inventive concepts will be apparent to those skilled in the art from this disclosure.

The present disclosure provides energy devices with ultra-capacitor structures and battery structures, and methods thereof. Consumers continue to demand portable electronic devices with increased functionality, greater power-on time, and reduced size and weight. Because portable electronic devices can include numerous components, each of which can require significant power, charging and powering such devices under typical consumer usage patterns can present problems.

In addition, because consumers expect devices to last a period of years without battery replacement, care must be taken in the design of such devices to optimize both the battery lifetime, or number of calendar months of useful operation, and the battery cycle life, or the amount of time each full charge of the battery will last under normal operating conditions.

Advantageously, the present disclosure provides energy devices which can be rapidly charged without reducing cycle life. Energy storage devices, including ultra-capacitor structures and batteries, such as lithium ion or nickel cadmium batteries, may be characterized by an energy density and a power density. The energy density (also known as the specific energy) of an energy storage device is defined as the amount of energy stored per unit mass of the device, and the power density is defined as the rate per unit mass at which energy may be transferred to or from the device.

Different types of energy storage devices may be compared by comparing their respective energy densities and power densities. As one example, an activated carbon ultra-capacitor may have, for example one-tenth of the energy density of a conventional lithium-ion rechargeable battery, but have, for example, 10 to 100 times the power density of the conventional lithium-ion rechargeable battery. Therefore, an ultra-capacitor may deliver a relatively large amount of energy to an electrical load over a relatively short time, as compared to a battery that may deliver a relatively small amount of energy to an electrical load over a relatively long time. Similarly, an ultra-capacitor may be charged over a relatively short period of time, for example, 10 to 100 times faster, than a conventional battery.

As used herein, an ultra-capacitor is, for instance, an electrochemical capacitor that includes an electrolyte disposed between electrodes. An electrolyte is a substance through which electricity may pass, and may be, for example, a fluid, solid, semisolid, or a material capable of flowing. One example of an ultra-capacitor is an electrochemical double layer capacitor (EDLC), which may store electrical energy by the separation of charge, for instance, in a double layer of ions, at the interface between the surface of a conductive electrode and an electrolyte. Another term for an ultra-capacitor is a supercapacitor. An ultra-capacitor structure may include one or more ultra-capacitor cells.

By way of explanation, a conventional battery, such as a lithium ion or nickel cadmium battery, can exhibit different behavior in different states of charge. At a low state of charge, for example, 0-20%, the battery may be damaged with rapid charging, necessitating trickle charging of the battery over long times to avoid damage. At a medium state of charge, for example, 20-75%, the battery may be rapidly charged without as much damage. And, at a high state of charge, for example, 75-100%, the batter may also be damaged with rapid charging. In other examples, charging the battery at a high temperature can also lead to damage.

Advantageously, an energy device for an electronic device as described herein includes an ultra-capacitor structure and a battery structure. The ultra-capacitor structure can be used as a front-end to enable overall rapid charging of the energy device and immediate usage of the electronic device. For instance, the energy device can rapidly charge the ultra-capacitor structure and allow for usage of the electronic device within minutes, and trickle charge the battery from a low state of charge to a medium state of charge, at which time, the battery may be rapidly charged from the medium state of charge to a high state of charge.

Generally stated, provided herein, in one aspect, is an energy device. The energy device includes: an ultra-capacitor structure having a power input terminal; and a battery structure electrically connected to the ultra-capacitor structure via a switching element, the switching element being selectively controllable between a first state and a second state, wherein the first state functions as a pass through to electrically connect the battery structure to the power input terminal of the ultra-capacitor structure, and the second state functions to electrically isolate the battery structure from the power input terminal of the ultra-capacitor structure.

In one embodiment, the energy device is capable of receiving a first voltage from the power input terminal and delivering a second voltage to charge the battery structure, wherein the first voltage and the second voltage are different voltages. In another embodiment, the energy device is capable of receiving a first current from the power input terminal and delivering a second current to charge the battery structure, wherein the first current and the second current are different currents.

In a further embodiment, the energy device further comprises a second switching element being electrically connected to the battery structure and the power output terminal, the second switching element being selectively controllable between a third state and a fourth state, wherein the third state functions to electrically connect the battery structure to the power output terminal and the fourth state functions to electrically isolate the battery structure from the power output terminal. In such a case, in one example, the energy device further includes a third switching element being electrically connected to the ultra-capacitor structure and an power output terminal, the third switching element being selectively controllable between a fifth state and a sixth state, wherein the fifth state functions to electrically connect the ultra-capacitor structure to the power output terminal and the sixth state functions to electrically isolate the ultra-capacitor structure from the power output terminal.

In one implementation, the energy device further includes a power supply, the power supply being electrically connected to the power input terminal of the ultra-capacitor structure, wherein the power supply charges the battery structure in the first state of the switching element. In another implementation, the energy device is capable of charging the battery structure with energy from the ultra-capacitor structure.

In another implementation, the ultra-capacitor structure buffers energy from the power input terminal. In a further implementation, the ultra-capacitor structure protects the battery structure from voltages or currents from the power input terminal thereof.

In another aspect, a method is presented. The method includes: providing an energy device comprising: an ultra-capacitor structure having a power input terminal; and a battery structure electrically connected to the ultra-capacitor structure; providing electrical power to the power input terminal of the ultra-capacitor structure; and selectively charging the battery structure through the ultra-capacitor structure using at least a portion of the electrical power provided to the power input terminal thereof.

In one embodiment, the charging comprises selectively charging the battery structure responsive to a first charge state thereof, and the method further comprises: selectively electrically isolating the battery structure from the ultra-capacitor structure responsive to a second charge state of the battery structure, wherein the first charge state and the second charge state are different charge states of the battery structure.

In another embodiment, providing the electrical power comprises providing the electrical power with a first voltage, and selectively charging the battery structure comprises: selectively charging the battery structure with the at least a portion of the electrical power with a second voltage, wherein the first voltage and the second voltage are different voltages.

In a further embodiment, providing the electrical power comprises providing the electrical power with a first current, and selectively charging the battery structure comprises: selectively charging the battery structure with the at least a portion of the electrical power with a second current, wherein the first current and the second current are different currents.

In one implementation, the energy device comprises a power output terminal and the method further comprises selectively powering the power output terminal with energy from the battery structure.

In another implementation, the energy device comprises a power output terminal and the method further comprises selectively powering the power output terminal with energy from the ultra-capacitor structure.

In a further implementation, the energy device comprises a power output terminal and the method further comprises selectively powering the power output terminal with energy from both the battery structure and the ultra-capacitor structure.

In another aspect, an electronic system is presented. The electronic system includes: an energy device, the energy device comprising: an ultra-capacitor structure having a power input terminal; and a battery structure electrically connected to the ultra-capacitor structure via a switching element, the switching element being selectively controllable between a first state and a second state, wherein the first state functions as a pass through to electrically connect the battery structure to the power input terminal of the ultra-capacitor structure, and the second state functions to electrically isolate the battery structure from the power input terminal of the ultra-capacitor structure; and a power supply, the power supply being electrically connected to the power input terminal of the ultra-capacitor structure, wherein the power supply charges the battery structure in the first state of the switching element.

Reference is made below to the drawings, which are not drawn to scale for ease of understanding, wherein the same reference numbers used throughout different figures designate the same or similar components.

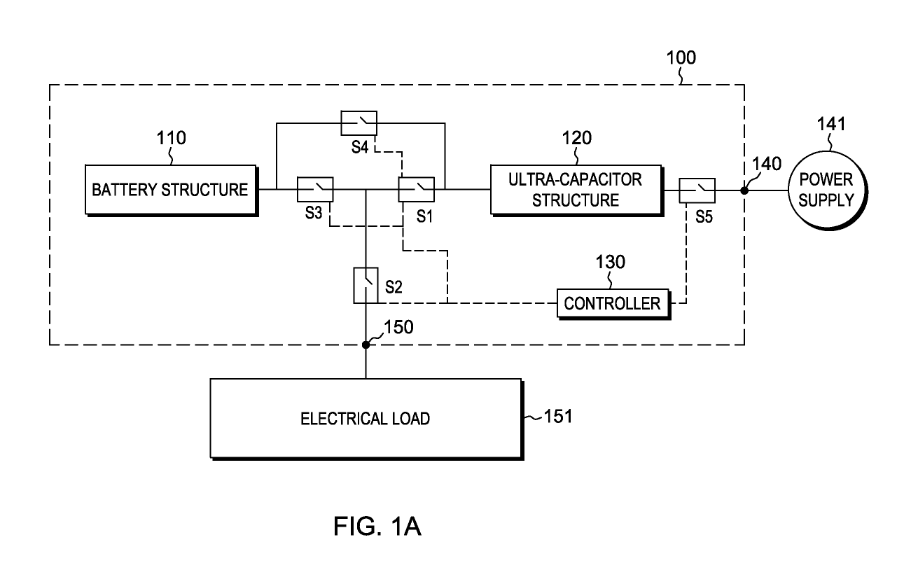

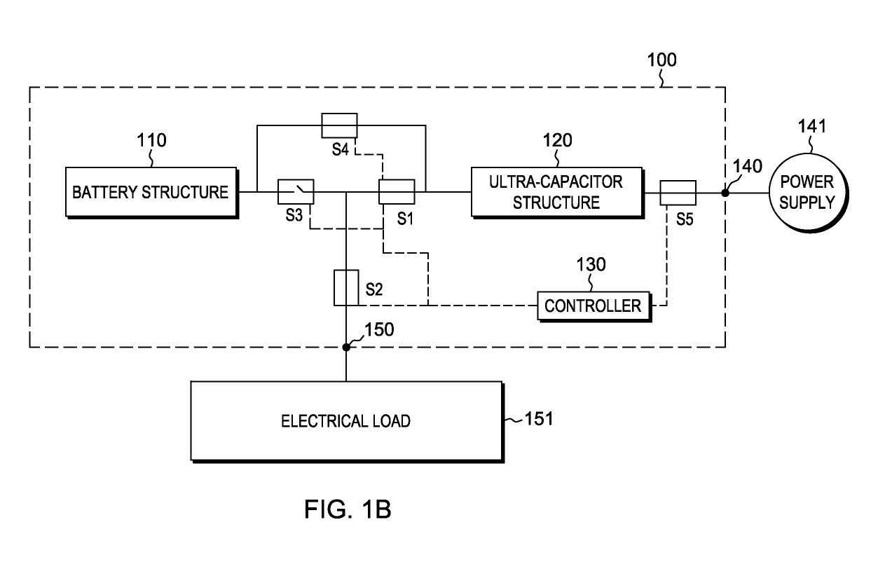

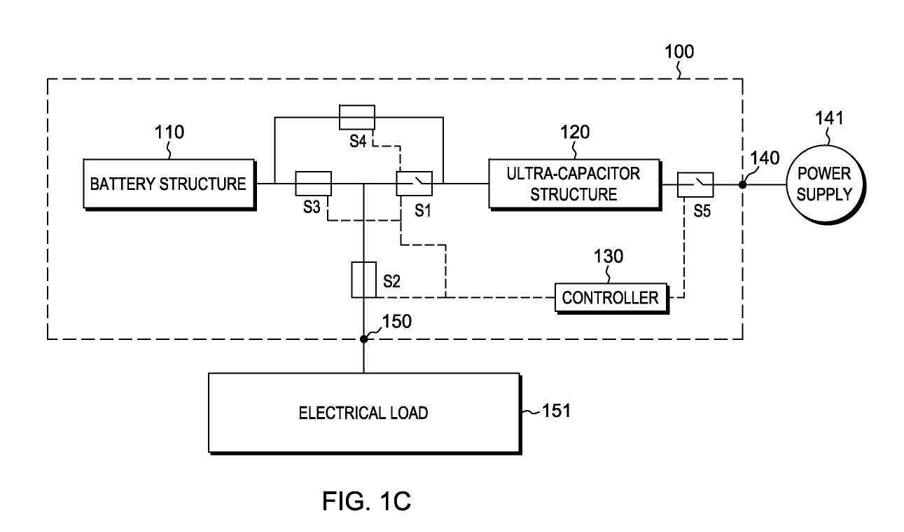

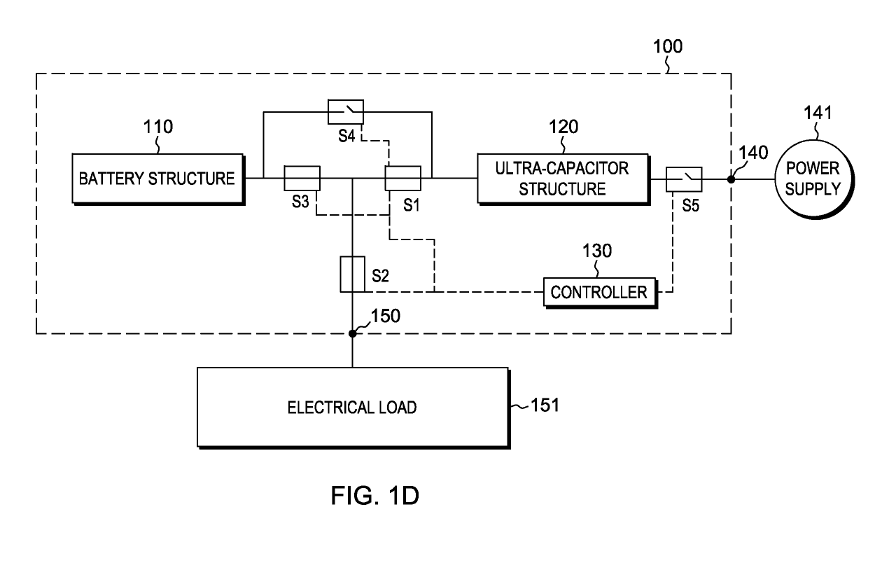

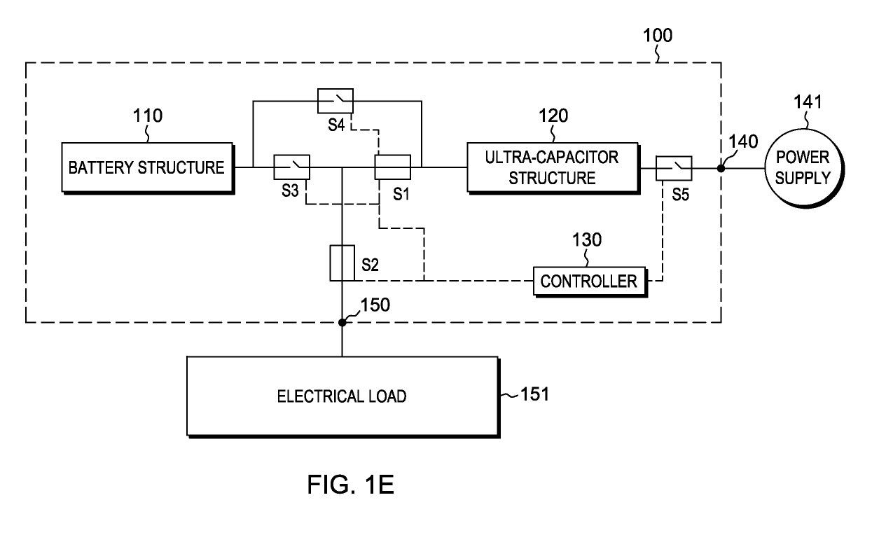

FIG. 1A is a block diagram of an electronic system with an energy device 100, in accordance with one or more aspects of the present invention. In the illustrated embodiment, energy device 100 includes an ultra-capacitor structure 120, a battery structure 110, and numerous switching elements S1-S5. In addition, battery structure 110 is electrically connected to ultra-capacitor structure 120 via switching element S4. Further, switching element S4 can be controllable between a first state and a second state. The first state (e.g., closed circuit) can function as a pass through to electrically connect battery structure 110 to a power input terminal 140, and the second state (e.g., open circuit) can function to electrically isolate battery structure 110 from power input terminal 140.

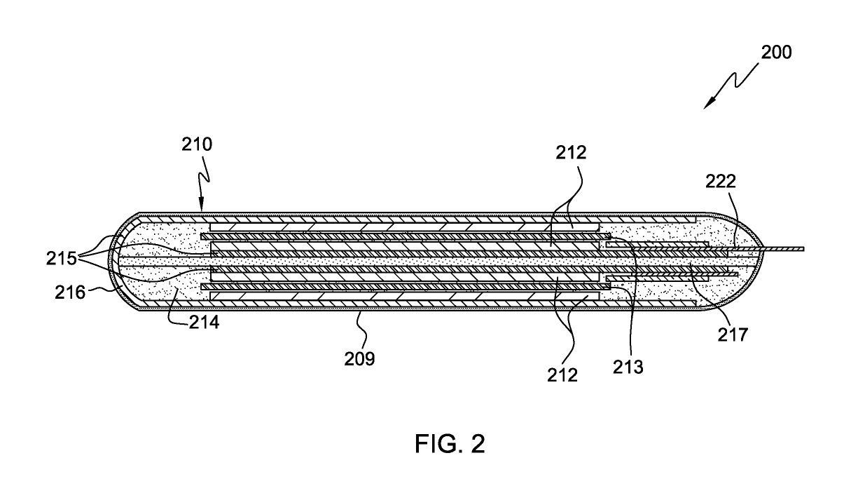

For example, ultra-capacitor structure 120 can include numerous ultra-capacitor cells, which can be interconnected to provide numerous currents or voltages. Further aspects of ultra-capacitor structures are described below with respect to FIG. 2.

With respect to FIG. 1A, in one embodiment, energy device 100 includes another switching element S3, controllable between a third state and a fourth state. The third state (e.g., closed circuit) can function to electrically connect battery structure 110 to a power output terminal 150, and the second state (e.g., open circuit) can function to electrically isolate battery structure 110 from power output terminal 150.

In another embodiment, energy device 100 includes another switching element S1, controllable between a fifth state and a sixth state. The fifth state (e.g., closed circuit) can function to electrically connect ultra-capacitor structure 120 to power output terminal 150, and the sixth state (e.g., open circuit) can function to electrically isolate ultra-capacitor structure 120 from power output terminal 150. In another embodiment, a power supply 141 is electrically connected to power input terminal 140. In another embodiment, output terminal 150 can include numerous connectors to accept numerous voltages or currents, allowing energy device 100 to power electrical load 151 with numerous different voltages or currents at the same time.

In a further embodiment, energy device 100 can receive a first voltage from power input terminal 140. In such a case, a power supply 141 can be connected to power input terminal 140, and battery structure 110 and ultra-capacitor structure 120 can be charged by power supply 141.

In one implementation, the switches are can be interspersed, or co-located, with ultra-capacitor cells of ultra-capacitor structure 120, and implemented using discrete electronics, such as discrete field-effect transistors. In another embodiment, the switching mechanism can be implemented in one or more centralized integrated circuits, such as, for example, an application specific integrated circuit (ASIC) or a controller 130, such as an embedded micro-controller. In such a case, separate or combined control lines and power lines can be provided to interconnect the multiple ultra-capacitor cells of the ultra-capacitor structure to the switching mechanism.

In another implementation, controller 130 can control charging of energy device 100, including battery structure 110 and ultra-capacitor structure 120 responsive to various variables, including, for example, state of charge of battery structure 110, state of charge of ultra-capacitor structure 120, and temperature of battery structure 110 (e.g., to reduce charging rate if the battery structure is at an elevated temperature greater than room temperature). As one specific example, the controller can be an MSP430 Micro-controller available from Texas Instruments, Inc., of Dallas, Tex.

In a further implementation, energy device 100 provides overvoltage protection for battery structure 110. If an excessive voltage is applied to a battery structure for an excessive period of time, the battery can be irreparably damaged. In one example, the battery electrodes can be weakened and damaged due to excessive voltage. Advantageously, energy device 100 includes an ultra-capacitor structure 120 which can tolerate much higher voltages than a conventional battery. By pass-through charging battery structure 110 via ultra-capacitor structure 120, higher voltages or voltage spikes can be mitigated through the ultra-capacitor, thereby protecting battery structure 110. Such a configuration can also allow for the reduction of components, replacing overvoltage circuits, for example, and conserving energy.

By way of summary, FIGS. 1B-1E depict energy device 100 with various configurations of switching elements S1-S5. In particular, FIG. 1B describes charging states of energy device 100, and FIGS. 1C-1E describe discharging, or powering states, of energy device 100. In one example, the various configurations can be selected using controller 130, in response to changing requirements for electrical power for a mobile electronic device. In another example, the various configurations can be selected responsive to one or more parameters, such as the charge state of battery structure 110, without the need for a controller.

FIG. 1B depicts energy device 100 in a pass through state electrically connecting a battery structure 210 to a power input terminal thereof, in accordance with one or more aspects of the present invention. In the illustrated embodiment, switching elements S1, S4, S5 are closed. Therefore, energy device 100 can receive a first voltage or current from power input terminal 140 and deliver a second voltage or current to charge battery structure 110, facilitating charging of energy device 100. The voltage or current received from power input terminal 140 can be different from the voltage or current delivered to battery structure 110, with the voltages or currents being modified through ultra-capacitor structure 120.

In another embodiment, power supply 141 can be electrically connected to power input terminal 140 to charge battery structure 110. In a further embodiment, energy device 100 can charge battery structure 110 with energy from ultra-capacitor structure 120.

By way of example, in one implementation, ultra-capacitor structure 120 can buffer energy from power input terminal 140, and/or protect battery structure 110 from voltages or currents therefrom. For instance, when battery structure 110 is nearly depleted and in a low state of charge (e.g., 0-20% charge), it can be advantageous to prevent rapid charging in order to avoid irreparably damaging battery structure 110. In such a case, ultra-capacitor structure 120 can be rapidly charged, and battery structure 110 can be trickle charged until battery structure 110 reaches a higher charge state that supports rapid charging.

Advantageously, such a configuration can allow use of an electronic device with a fully depleted battery within only a few minutes of charging. For instance, in one specific example, a mobile phone can include energy device 100, with battery structure 110 and ultra-capacitor structure 120 fully depleted. In such an example, energy device 100 of the mobile phone can be connected to power supply 141, and ultra-capacitor structure 120 can be charged within approximately two minutes. At such time, power supply 140 can be disconnected and energy device 100, using energy stored within ultra-capacitor structure 120 thereof can provide 20-30 minutes of talk-time for the mobile phone. In addition, power supply 140 can remain connected, and battery structure 110 can be trickle charged from a low state of charge (e.g., 0-20% charge) until it reaches a medium state of charge (e.g., 20% charge), and thereafter rapidly charged from 20% to 75% state of charge. Trickle charging refers to charging a battery at a fraction of the nominal charging rate, for example, at one-tenth the nominal charging current. In one example, a battery can be rapidly charged at a power rate corresponding to twice the maximum discharge rate.

FIG. 1C depicts energy device 100 in a state electrically connecting the battery structure to the power output terminal thereof, in accordance with one or more aspects of the present invention. In the illustrated embodiment, switching elements S2, S3 are closed. Therefore, battery structure 110 is electrically connected to power output terminal 150, and can be used to power electrical load 151. In one embodiment, energy device 100 can charge from power supply 141 and concurrently therewith power electrical load 151. In another embodiment, charging and powering may be sequential.

The charging states (see FIG. 1B) and discharging states (see FIG. 1C-1E) can be combined so that energy device 100 simultaneously charges (including charging battery structure 110 and/or ultra-capacitor structure 120) and powers an electrical load, through appropriately setting switching elements S1-S5 (e.g., switching elements S1, S2, S3, S5 can be closed to allow simultaneous charging and powering operations).

FIG. 1D depicts energy device 100 in a state electrically connecting the ultra-capacitor structure and the battery structure to the power output terminal thereof, in accordance with one or more aspects of the present invention. In the illustrated embodiment, switching elements S1, S2, S3 are closed. Therefore, battery structure 110 and ultra-capacitor structure 120 are electrically connected to power output terminal 150, and can both be used to power electrical load 151. In one embodiment, battery structure 110 and ultra-capacitor structure 120 can power different electrical components of electrical load 151. In another embodiment, the same electrical components can be powered by both battery structure 110 and ultra-capacitor structure 120.

In one example, a portable electronic device, such as a mobile phone, can have an electrical load 151 with a minimum cut-off voltage V_{co}. In such a case, once battery structure 110 is depleted to a level below V_{co}, battery structure 110 can no longer power electrical load 151, even if battery structure 110 has remaining energy. Because of such limitations of conventional batteries, the remaining energy can be wasted, leading to increased bulk and reduced power-on time of the electronic device. Advantageously, energy device 100 can include ultra-capacitor structure 120 with multiple ultra-capacitor cells, some of which can have a voltage below V_{co}, allowing battery structure 110 to discharge the remaining energy through ultra-capacitor structure 120.

FIG. 1E depicts energy device 100 in a state electrically connecting the ultra-capacitor structure to power output terminal 150, in accordance with one or more aspects of the present invention. In the illustrated embodiment, switching elements S1, S2 are closed, and switching element S3 is open. Therefore, ultra-capacitor structure 120 are electrically connected to power output terminal 150, and can be used to power electrical load 151.

In the embodiment of FIG. 1E, battery structure 110 is not electrically connected to power output terminal 150. Such a configuration allows for removal of battery structure 110 and replacement with a different battery structure, or hot-swapping of battery structures during operation of the electronic device. Hot-swapping is supported in such an example because electrical load 151 is powered by energy device 100 exclusively by ultra-capacitor structure 120 when switching element S3 is open circuited.

FIG. 2 is a cross-sectional elevational view of an ultra-capacitor structure 200, in accordance with one or more aspects of the present invention. As depicted, in one embodiment, ultra-capacitor structure 210 includes one or more ultra-capacitors cells. Each ultra-capacitor cell may include, for example, two electrodes 212 separated by a separator 213, and electrically connected by ions of an electrolyte 214 located between the two electrodes.

Electrodes 212 may be fabricated of a porous, or spongy, material, which may have a large specific surface area (such as activated carbon, amorphous carbon, carbon aerogel, graphene, or carbon nano-tubes), for instance, a specific surface area of 500-1000 square meters per gram, due to micro-porosity, and electrolyte 214 may include a solvent with dissolved chemicals, such as potassium hydroxide (KOH). Electrodes 212 may be connected to one or more current collector(s) 215, which may include a conductive material, such as a metal, for instance, aluminum or copper. Current collector(s) 215 may act as terminals, such as positively charged anodes or negatively charged cathodes, of the ultra-capacitors cells of ultra-capacitor structure 200.

In the embodiment of FIG. 2, in an inverted bipolar configuration, the two ultra-capacitor cells are coupled in series, and separated by a dielectric sealer 217. These ultra-capacitors cells may share, for example, a bipolar C-shaped current collector 216 within ultra-capacitor structure 210.

Advantageously, the inverted bipolar configuration allows bipolar C-shaped current collector 216 to be accessed from anywhere on the surface of the ultra-capacitor cells, because in an inverted bipolar configuration, bipolar C-shaped current collector 216 wraps around both ultra-capacitor cells, at least partially encircling them. In such an inverted bipolar configuration, contact tabs 120 may connect to bipolar C-shaped current collector 216 or to current collectors 215 located within the ultra-capacitor cells of ultra-capacitor structure 200, providing, for example, access to different voltage levels from ultra-capacitor structure 210. For instance, if each ultra-capacitor cell has a voltage capacity of 2.7 volts (V), then bipolar C-shaped current collector 216 may deliver 2.7 V, because it is connected in series with one ultra-capacitor cell, and multi-contact tab 122 may deliver 5.4 V, because it is connected in series with both ultra-capacitor cells.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “comprise” (and any form of comprise, such as “comprises” and “comprising”), “have” (and any form of have, such as “has” and “having”), “include” (and any form of include, such as “includes” and “including”), and “contain” (and any form of contain, such as “contains” and “containing”) are open-ended linking verbs. As a result, a method or device that “comprises,” “has,” “includes,” or “contains” one or more steps or elements possesses those one or more steps or elements, but is not limited to possessing only those one or more steps or elements. Likewise, a step of a method or an element of a device that “comprises,” “has,” “includes,” or “contains” one or more features possesses those one or more features, but is not limited to possessing only those one or more features. Furthermore, a device or structure that is configured in a certain way is configured in at least that way, but may also be configured in ways that are not listed.

The corresponding structures, materials, acts, and equivalents of all means or step plus function elements in the claims below, if any, are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of one or more aspects of the invention and the practical application, and to enable others of ordinary skill in the art to understand one or more aspects of the invention for various embodiments with various modifications as are suited to the particular use contemplated.

1. An energy device, the energy device comprising:
an ultra-capacitor structure electrically connected to a power supply; and
a battery structure electrically connected to the power supply through the ultra-capacitor structure, the battery structure being electrically connected to the ultra-capacitor structure, wherein the ultra-capacitor is rapidly charged from the power supply, and the battery structure is charged by the power supply, through the ultra-capacitor structure, based on the state of charge of the battery structure, such that the battery structure is rapidly charged by the ultra-capacitor structure, when the battery is at a medium state of charge, and the battery structure is trickle charged by the ultra-capacitor structure when the battery structure is at a high or a low state of charge, the medium state of charge being between the high and the low states of charge.

2. The energy device of claim 1, wherein the energy device receives a first voltage from the power supply at the ultra-capacitor structure and delivers a second voltage from the ultra-capacitor structure to charge the battery structure, wherein the first voltage and the second voltage are different voltages.

3. The energy device of claim 1, wherein the energy device receives a first current from the power supply at the ultra-capacitor structure and delivers a second current from the ultra-capacitor structure to charge the battery structure, wherein the first current and the second current are different currents.

4. The energy device of claim 1, further comprising a switching element electrically connected to the battery structure and a power output terminal to electrically connect to an electrical load, the switching element being selectively controllable between a first state and a second state, wherein the first state functions to electrically connect the battery structure to the power output terminal and the second state functions to electrically isolate the battery structure from the power output terminal.

5. The energy device of claim 4, further comprising a second switching element electrically connected to the ultra-capacitor structure and the power output terminal, the second switching element being selectively controllable between a third state and a fourth state, wherein the third state functions to electrically connect the ultra-capacitor structure to the power output terminal and the fourth state functions to electrically isolate the ultra-capacitor structure from the power output terminal.

6. (canceled)

7. (canceled)

8. The energy device of claim 1, wherein the ultra-capacitor structure buffers energy from the power supply.

9. The energy device of claim 1, wherein the ultra-capacitor structure conserves energy within the energy device by functioning as an overvoltage protector to protect the battery structure from damage caused by a spike from the power supply.

10. A method comprising:
providing an energy device, the energy device comprising:
an ultra-capacitor structure electrically connected to a power supply; and
a battery structure electrically connected to the power supply through the ultra-capacitor structure, the battery structure being electrically connected to the ultra-capacitor structure;
providing electrical power from the power supply to the ultra-capacitor structure; and
selectively charging the battery structure through the ultra-capacitor structure using at least a portion of the electrical power provided by the power supply to the ultra-capacitor structure, wherein the selectively charging comprises rapidly charging the ultra-capacitor structure from the power supply and charging the battery structure from the power supply, through the ultra-capacitor structure, based on the state of charge of the battery structure, such that the battery structure is rapidly charged by the ultra-capacitor structure, when the battery is at a medium state of charge, and the battery structure is trickle charged by the ultra-capacitor structure when the battery structure is at a high or a low state of charge, the medium state of charge being between the high and the low states of charge.

11. The method of claim 10, wherein the selectively charging further comprises selectively charging the battery structure responsive to a first charge state thereof, and the method further comprises:
selectively electrically isolating the battery structure from the ultra-capacitor structure responsive to a second charge state of the battery structure, wherein the first charge state and the second charge state are different charge states of the battery structure.

12. The method of claim 10, wherein providing the electrical power comprises providing the electrical power with a first voltage, and selectively charging the battery structure further comprises:
selectively charging the battery structure with the at least a portion of the electrical power with a second voltage, wherein the first voltage and the second voltage are different voltages.

13. The method of claim 10, wherein providing the electrical power comprises providing the electrical power with a first current, and selectively charging the battery structure further comprises:
selectively charging the battery structure with the at least a portion of the electrical power with a second current, wherein the first current and the second current are different currents.

14. The method of claim 10, wherein the energy device comprises a power output terminal electrically connected to an electrical load and the method further comprises selectively powering the electrical load via the power output terminal with energy from the battery structure.

15. The method of claim 10, wherein the energy device comprises a power output terminal electrically connected to an electrical load and the method further comprises selectively powering the electrical load via the power output terminal with energy from the ultra-capacitor structure.

16. The method of claim 10, wherein the energy device comprises a power output terminal electrically connected to an electrical load and the method further comprises selectively powering the electrical load via the power output terminal with energy from both the battery structure and the ultra-capacitor structure.

17. An electronic system comprising:
an energy device, the energy device comprising:
an ultra-capacitor structure electrically connected to a power supply; and
a battery structure electrically connected to the power supply through the ultra-capacitor structure, the battery structure being electrically connected to the ultra-capacitor structure, wherein the ultra-capacitor is rapidly charged from the power supply, and the battery structure is charged by the power supply, through the ultra-capacitor structure, based on the state of charge of the battery structure, such that the battery structure is rapidly charged by the ultra-capacitor structure, when the battery is at a medium state of charge, and the battery structure is trickle charged by the ultra-capacitor structure when the battery structure is at a high or a low state of charge, the medium state of charge being between the high and the low states of charge; and
the power supply.

18. The electronic system of claim 17, further comprising:
an electrical load, the electrical load being electrically connected to the energy device; and
a switching element being electrically connected to the battery structure and the electrical load, the switching element being selectively controllable between a first state and a second state, wherein the first state functions to electrically connect the battery structure to the electrical load and the second state functions to electrically isolate the battery structure from the electrical load.

19. The electronic system of claim 18, further comprising a second switching element being electrically connected to the ultra-capacitor structure and the electrical load, the second switching element being selectively controllable between a third state and a fourth state, wherein the third state functions to electrically connect the ultra-capacitor structure to the electrical load and the fourth state functions to electrically isolate the ultra-capacitor structure from the electrical load.

20. The electronic system of claim 17, wherein the energy device receives a first voltage or current from the power supply at the ultra-capacitor structure and delivers a second voltage or current from the ultra-capacitor structure to charge the battery structure, wherein the first voltage or current and the second voltage or current are different voltages.
